(19) United States
(12) Patent Application Publication
(10) Pub. No.: US 2025/0381090 A1
(43) Pub. Date: Dec. 18, 2025

(54) ROLLATOR THAT CAN BE STABLY FOLDED

(71) Applicant: ZIJIE LIU, Zhongshan (CN)

(72) Inventor: ZIJIE LIU, Zhongshan (CN)

(21) Appl. No.: 18/766,965

(22) Filed: Jul. 9, 2024

(30) Foreign Application Priority Data
Jun. 13, 2024 (CN) 202421353093.1

(51) Int. Cl. A61H 3/04

(52) U.S. Cl. CPC A61H 3/04; A61H 2201/0161

(57) ABSTRACT

A rollator that can be stably folded is provided, which includes a left frame, a right frame, a first foldable frame, and a second foldable frame. The left frame and the right frame are symmetrically arranged; the first foldable frame and the second foldable frame are provided between the left frame and the right frame and can rotate and be folded along a center of a rotary shaft. The first foldable frame is connected to the second foldable frame through the rotary shaft. One end of the first foldable frame is connected to the left frame through a first connection rod mechanism, and the other end thereof is hinged to the right frame. One end of the second foldable frame is connected to the right frame through a second connection rod mechanism, and the other end thereof is hinged to the left frame.

### CROSS-REFERENCE TO RELATED APPLICATIONS

This application claims priority to Chinese Patent Application No. 202421353093.1, filed on Jun. 13, 2024, which is hereby incorporated by reference in its entirety.

### TECHNICAL FIELD

The present disclosure relates to the field of rollator technologies, and in particular, to a rollator that can be stably folded.

### BACKGROUND

Most rollators on the market adopt an X-shaped cross pipe design to meet a folding need. This design can render the rollator body more compact, convenient to carry and store during folding. However, this design has certain stability issues when deployed. Especially for single tube folded rollator, there is often a situation where left and right frames sway back and forth during use, which brings certain inconvenience and safety hazards to a normal use of a user.

Therefore, it is urgent to redesign and optimize a folding structure of the rollator to improve its stability and safety.

### SUMMARY

The present application aims to solve the above-mentioned technical problems and provide a rollator that can be stably folded with high folding and unfolding stability, which is not easy to shake.

The rollator that can be stably folded, including a left frame, a right frame, a first foldable frame, and a second foldable frame, where the left frame and the right frame are symmetrically arranged; the first foldable frame and the second foldable frame are provided between the left frame and the right frame and be capable of rotating and being folded along a center of a rotary shaft; the first foldable frame is connected to the second foldable frame through the rotary shaft; one end of the first foldable frame is connected to the left frame through a first connection rod mechanism, and the other end thereof is hinged with the right frame; one end of the second foldable frame is connected to the right frame through a second connection rod mechanism, and the other end thereof is hinged with the left frame.

In an embodiment of the present disclosure, the first foldable frame includes a first crossbar that be capable of abutting against the left frame and a first articulated rod fixed on the first crossbar and hinged with the right frame; the second foldable frame includes a second crossbar that be capable of abutting against the right frame and a second articulated rod fixed on the second crossbar and hinged with the left frame;
the rotary shaft runs through middles of the first articulated rod and the second articulated rod, and is pivoted to the first articulated rod and the second articulated rod.

In an embodiment of the present disclosure, both the first crossbar and the second crossbar are provided with a limit block; the left frame and the right frame are provided with a limit slot corresponding to the limit block, and the limit slot is clamping connection with the limit block.

In an embodiment of the present disclosure, the right frame includes a right front frame and a right rear frame that are integrally formed, and the first articulated rod is provided with a first front rod and a first rear rod corresponding to the right front frame and the right rear frame; where the first front rod is hinged with the right front frame, and the first rear rod is hinged with the right rear frame.

In an embodiment of the present disclosure, the left frame includes a left front frame and a left rear frame that are integrally formed, and the second articulated rod is provided with a second front rod and a second rear rod corresponding to the left front frame and the left rear frame, where the second front rod is hinged with the left front frame, and the second rear rod is hinged with the left rear frame.

In an embodiment of the present disclosure, the first connection rod mechanism includes a first connection rod and a first articulated shaft, one end of the first connection rod is hinged with the left frame and the other end thereof is hinged with the first foldable frame; the first articulated shaft penetrates on the first foldable frame, where the left frame is provided with a left articulated seat, and the first connection rod is hinged with the left articulated seat.

In an embodiment of the present disclosure, the second connection rod mechanism includes a second connection rod and a second articulated shaft; one end of the second connection rod is hinged with the right frame and the other end thereof is hinged with the second foldable frame, the second articulated shaft penetrates on the second foldable frame, where the right frame is provided with a right articulated seat, and the second connection rod is hinged with the right articulated seat.

In an embodiment of the present disclosure, a hook is further provided on the crossbar configured to hang an object.

Compared with existing technology, the beneficial effects of the present application are as follows.

The present application provides a rollator that can be stably folded, by providing with two double foldable frames and the first foldable frame and the second foldable frames being rotated and folded along a center of the rotary shaft, fast and convenient folding and unfolding operations can be achieved, it is convenient for a user to carry and store without shaking and thereby improving stability. Furthermore, the first foldable frame and second foldable frame are connected by the rotary shaft to ensure stable folding connectivity, enhance the firmness and durability of an overall structure. The first foldable frame and second foldable frame are respectively connected to the left frame and right frame through connection rod mechanisms, rendering the rollator more stable during folding and unfolding. This design not only considers convenience and stability of use, but also takes into account folding convenience and space saving, thereby providing the user with more practicality and a comfortable driving experience.

### BRIEF DESCRIPTION OF DRAWINGS

In order to provide a clearer explanation of the technical solution in the embodiments of the present application, a brief introduction will be given below to the accompanying drawings required in the description of the embodiments.

FIG. 1 is a three-dimensional schematic diagram of a rollator that can be stably folded in the present application.

FIG. 2 is a schematic diagram of a folded state of the rollator that can be stably folded in the present application.

FIG. 3 is an exploded view of the rollator that can be stably folded in the present application.

### DESCRIPTION OF EMBODIMENTS

The following is a further explanation of the present disclosure in combination with the accompanying drawings:

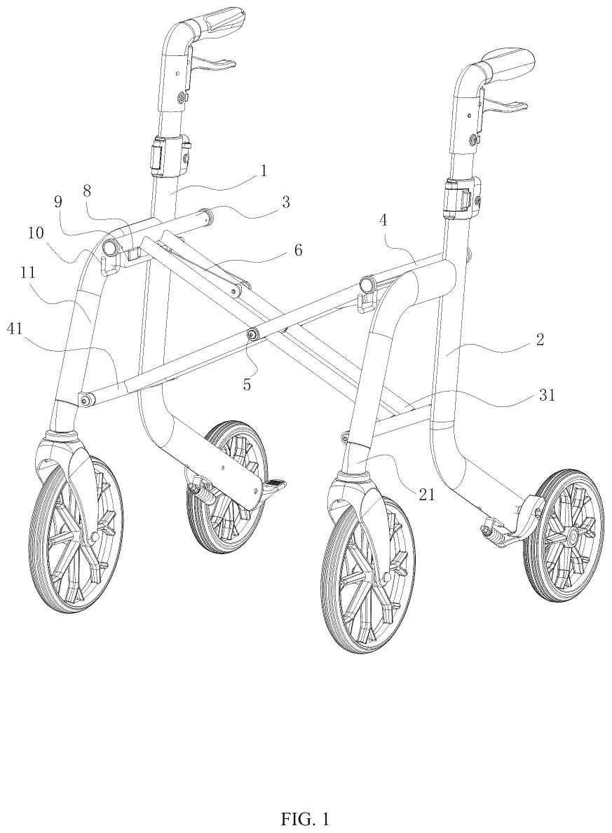

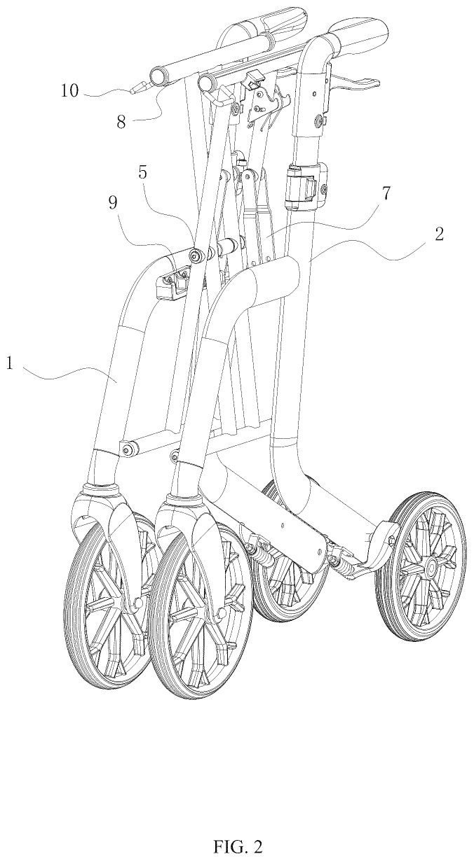

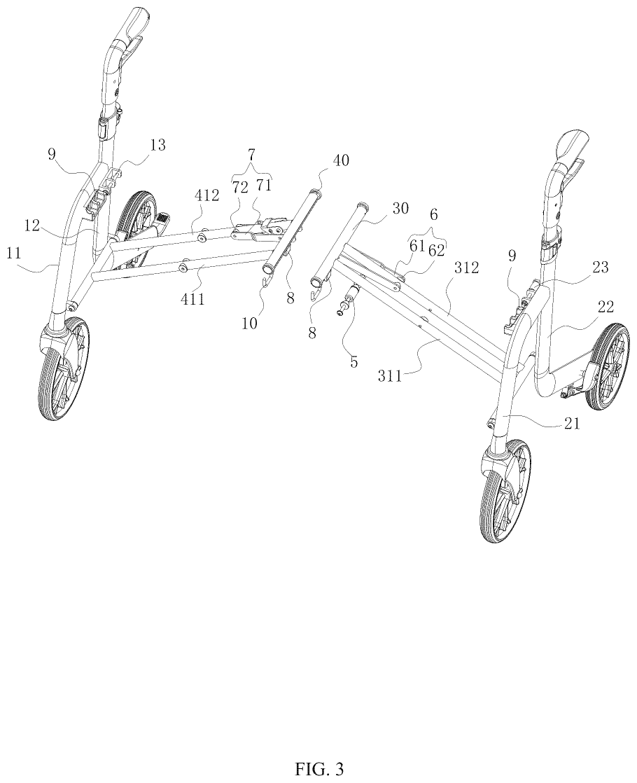

As shown in FIGS. 1-3, a rollator that can be stably folded includes a left frame 1, a right frame 2, a first foldable frame 3, a second foldable frame 4, a rotary shaft 5, a first connection rod mechanism 6, a second connection rod mechanism 7, a first crossbar 30, a first articulated rod 31, a second crossbar 40, a second articulated rod 41, a limit block 8, a limit slot 9, a right front frame 21, a right rear frame 22, a first front rod 311, a first rear rod 312, a left front frame 11, a left rear frame 12, a second front rod 411, a second rear rod 412, a first connection rod 61, a first articulated shaft 62, a left articulated seat 13, a right articulated seat 23, a second connection rod 71, a second articulated shaft 72, and a hook 10.

The rollator that can be stably folded includes the left frame 1, the right frame 2, the first foldable frame 3, and the second foldable frame 4. The left frame 1 and the right frame 2 are symmetrically arranged; the first foldable frame 3 and the second foldable frame 4 are provided between the left frame 1 and the right frame 2 and can rotate and be folded along a center of the rotary shaft 5. The first foldable frame 3 is connected to the second foldable frame 4 through the rotary shaft 5. One end of the first foldable frame 3 is connected to the left frame 1 through the first connection rod mechanism 6, and the other end thereof is hinged with the right frame 2. One end of the second foldable frame 4 is connected to the right frame 2 through the second connection rod mechanism 7, and the other end thereof is hinged with the left frame 1. By providing with two foldable frames and a rotation and folding design of the first foldable frame and second foldable frame along the center of the rotary shaft, fast and convenience folding and unfolding operations are achieved, it is convenient for a user to carry and store, without shaking, which improves stability. Furthermore, the first foldable frame and the second foldable frame are connected by the rotary shaft, which ensures stable folding connectivity and enhancing firmness and durability of an overall structure. The first foldable frame and second foldable frame are respectively connected to the left and right frames through connection rod mechanisms, rendering the rollator more stable when folding and unfolding. This design not only considers convenience and stability of use, but also takes into account folding convenience and space saving, thereby providing the user with more practicality and a comfortable driving experience.

In an implementation, the first foldable frame 3 includes a first crossbar 30 that can be abutted against the left frame 1 and a first articulated rod 31 fixed on the first crossbar 30 and hinged with the right frame 2. The second foldable frame 4 includes a second crossbar 40 that can be abutted against the right frame 2, and a second articulated rod 41 fixed on the second crossbar 40 and hinged with the left frame 1.

The rotary shaft 5 runs through middles of the first articulated rod 31 and the second articulated rod 41, and is pivoted to the first articulated rod 31 and the second articulated rod 41. The first crossbar 30 and the second crossbar 40 can be tightly abutted against corresponding frames, and connected to the other side through the first articulated rod 31 and the second articulated rod 41, rendering the folding and unfolding movement of the foldable frame smoother and more reliable. The providing of the rotary shaft 5 effectively supports and connects the first foldable frame and the second foldable frame, ensuring the stability and durability during use.

In an implementation, both the first crossbar 30 and the second crossbar 40 are provided with a limit block 8; the left frame 1 and the right frame 2 are provided with a limit slot 9 corresponding to the limit block 8. The limit block 8 can be matched and clamping connection with the limit slot 9 to ensure that the first foldable frame and the second foldable frame are positioned according to predetermined position and angle during the folding and unfolding process, thereby improving the stability and reliability of the foldable frame. By interlocking the limit block 8 with the limit slot 9, the foldable frame can be firmly locked in a correct position after unfolding, and can be smoothly folded to a specified state during folding, thereby avoiding unnecessary folding, swaying or misalignment.

In an implementation, the right frame 2 includes a right front frame 21 and a right rear frame 22 that are integrated formed. The first articulated rod 31 is provided with a first front rod 311 and a first rear rod 312 corresponding to the right front frame 21 and the right rear frame 22. The first front rod 311 is hinged with the right front frame 21, and the first rear rod 312 is hinged with the right rear frame 22, so that the first articulated rod 31 can be stably connected to front and rear of the right frame, helping to support the stability of the entire structure and perform effective rotation and folding operations. An articulated connection between the right front frame 21 and the right rear frame 22 allows the frame to be rotated and adjusted flexibly, while the overall structure is sturdier and more durable through a connection of the first articulated rod 31.

In an implementation, the left frame 1 includes a left front frame 11 and a left rear frame 12 that are integrated formed, the second articulated rod 41 is provided with a second front rod 411 and a second rear rod 412 corresponding to the left front frame 11 and the left rear frame 12. The second front rod 411 is hinged with the left front frame 11, and the second rear rod 412 is hinged with the left rear frame 12, so that the second articulated rod 41 can be stably connected to the front and rear of the left frame, helping to support the stability of the entire structure and perform effective rotation and folding operations. The articulated connection between the left front frame 11 and the left rear frame 12 allows the frame to be rotated and adjusted flexibly, while the overall structure is sturdier and more durable through the connection of the second articulated rod 41.

In an implementation, the first connection rod mechanism 6 includes a first connection rod 61 and a first articulated shaft 62, one end of the first connection rod 61 is hinged with the left frame 1 and the other end thereof is hinged with the first foldable frame 3, the first articulated shaft 62 penetrates on the first foldable frame 3. The left frame 1 is provided with a left articulated seat 13, and the first connection rod 61 is hinged with the left articulated seat 13.

In an implementation, the second connection rod mechanism 7 includes a second connection rod 71 and a second articulated shaft 72; one end of the second connection rod 71 is hinged with the right frame 2 and the other end thereof is hinged with the second foldable frame 4, the second articulated shaft 72 penetrates on the second foldable frame 4. The right frame 2 is provided with a right articulated seat 23, and the second connection rod 71 is hinged with the right articulated seat 23.

In an implementation, the crossbar is further provided with a hook 10 configured to hang an object. This design can facilitate the user to hang small items such as bags, rain gear, etc., thereby increasing the practicality and convenience of the rollator.

The above is only preferred embodiments of the present disclosure and is not intended to limit it. Any modifications, equivalent substitutions, and improvements made within the spirit and principles of the present disclosure shall be included within the protection scope of the present disclosure.

What is claimed is:

1. A rollator that can be stably folded, comprising a left frame, a right frame, a first foldable frame, and a second foldable frame, wherein the left frame and the right frame are symmetrically arranged; the first foldable frame and the second foldable frame are provided between the left frame and the right frame and be capable of rotating and being folded along a center of a rotary shaft; the first foldable frame is connected to the second foldable frame through the rotary shaft; one end of the first foldable frame is connected to the left frame through a first connection rod mechanism, and the other end thereof is hinged with the right frame; one end of the second foldable frame is connected to the right frame through a second connection rod mechanism, and the other end thereof is hinged with the left frame.

2. The rollator that can be stably folded according to claim 1, wherein the first foldable frame comprises a first crossbar that be capable of abutting against the left frame and a first articulated rod fixed on the first crossbar and hinged with the right frame; the second foldable frame comprises a second crossbar that be capable of abutting against the right frame and a second articulated rod fixed on the second crossbar and hinged with the left frame;
the rotary shaft runs through middles of the first articulated rod and the second articulated rod, and is pivoted to the first articulated rod and the second articulated rod.

3. The rollator that can be stably folded according to claim 2, wherein both the first crossbar and the second crossbar are provided with a limit block; the left frame and the right frame are provided with a limit slot corresponding to the limit block, and the limit slot is clamp connection with the limit block.

4. The rollator that can be stably folded according to claim 2, wherein the right frame comprises a right front frame and a right rear frame that are integrally formed, and the first articulated rod is provided with a first front rod and a first rear rod corresponding to the right front frame and the right rear frame; wherein the first front rod is hinged with the right front frame, and the first rear rod is hinged with the right rear frame.

5. The rollator that can be stably folded according to claim 2, wherein the left frame comprises a left front frame and a left rear frame that are integrally formed, and the second articulated rod is provided with a second front rod and a second rear rod corresponding to the left front frame and the left rear frame, wherein the second front rod is hinged with the left front frame, and the second rear rod is hinged with the left rear frame.

6. The rollator that can be stably folded according to claim 1, wherein the first connection rod mechanism comprises a first connection rod and a first articulated shaft, one end of the first connection rod is hinged with the left frame and the other end thereof is hinged with the first foldable frame; the first articulated shaft penetrates on the first foldable frame, wherein the left frame is provided with a left articulated seat, and the first connection rod is hinged with the left articulated seat.

7. The rollator that can be stably folded according to claim 1, wherein the second connection rod mechanism comprises a second connection rod and a second articulated shaft; one end of the second connection rod is hinged with the right frame and the other end thereof is hinged with the second foldable frame, the second articulated shaft penetrates on the second foldable frame, wherein the right frame is provided with a right articulated seat, and the second connection rod is hinged with the right articulated seat.

8. The rollator that can be stably folded according to claim 3, wherein a hook is further provided on the crossbar configured to hang an object.
